(19) United States
(12) Patent Application Publication
(10) Pub. No.: US 2024/0298564 A1
(43) Pub. Date: Sep. 12, 2024

(54) REDUCING CARBON DIOXIDE LEVELS IN THE ATMOSPHERE

(71) Applicant: CARBON ALERT B.V., Hengelo (NL)

(72) Inventor: Jacobus Lambertus Van Merksteijn, Hengelo (NL)

(73) Assignee: CARBON ALERT B.V., Hengelo (NL)

(21) Appl. No.: 18/278,827

(22) PCT Filed: Feb. 25, 2022
(86) PCT No.: PCT/NL2022/050110

§ 371 Date: Aug. 24, 2023

(30) Foreign Application Priority Data
Feb. 26, 2021 (NL) 2027670

(51) Int. Cl. A01B 79/02; A01D 43/077

(52) U.S. Cl. CPC A01B 79/02; A01D 43/077

(57) ABSTRACT

A device and method for burying a material comprising carbon dioxide includes a material receiving section for obtaining the material comprising carbon dioxide. The device also includes a material burying section provided with a soil engaging mechanism and a material transporting system for transporting the obtained material via the soil engaging mechanism in a subsoil.

The present invention relates to reducing carbon dioxide levels in the atmosphere.

Ever since the industrial revolution, carbon dioxide levels in the atmosphere have increased. This increase has led to climate change resulting in a raise of the overall sea level and other major natural disasters. Lately, solutions are sought to reduce the level of carbon dioxide in the atmosphere. High tech and expensive solutions are to be avoided since budgets to reduce carbon dioxide levels are insufficient.

Governments support the planting of forests and other crops. Trees and crops are known to capture carbon dioxide from the atmosphere and use it to grow. It is widely known the carbon dioxide is captured in the trees and/or crops as carbon. This however is only a temporary solution since natural decaying or composting of trees and crops brings the same amount of carbon dioxide back into the atmosphere as was captured by growing the trees and crops. Therefore the net advantage of the trees and crops, over time, is close to zero.

It is an object of the invention to provide a simple and permanent manner to reduce carbon dioxide levels in the atmosphere.

To this end, the invention provides a method for capturing and storing CO2, the method comprising:
obtaining a material comprising carbon dioxide;
burying said obtained material in a subsoil.

It has been found that burying a material comprising carbon dioxide in a subsoil reduced the tendency of the material to bring the carbon dioxide back into the atmosphere. Therefore burying material containing carbon dioxide in the subsoil, meaning below ground level, provides a more permanent reduction of the carbon dioxide in the atmosphere.

It is noted that CO2 is stored as carbon in the material. However, since by storing the carbon CO2 is effectively removed from the atmosphere, storing carbon-containing matter is effectively a CO2-storage process.

Preferably, the step of obtaining the material comprises harvesting a crop material. Crop material captures carbon dioxide during growing. By harvesting this crop material and burying the material in a subsoil, the carbon dioxide captured by the crop material is captured below the ground surface and prevented from re-entering the atmosphere.

Preferably, the method further comprises, before the step of burying:
compressing the obtained material into discrete or continuous packages.

Discrete packages may be formed by compressing the material into molds. A continuous package may be formed by pressing the material through a mold, for example an extrusion mold. Preferably, the step of compressing additionally comprises surrounding the discrete or continuous packages into a plastic covering. The plastic covering keeps oxygen away from the material so that the tendency of the material comprising carbon dioxide to decompose and re-enter the carbon dioxide in the environment is reduced. Since the plastic covering is configured to keep oxygen away from the material so as to prevent decomposition, the plastic is obviously resistant to biodegradation.

Preferably, the step of burying comprises bringing the material to a depth below groundwater level. It has been found that the tendency to decompose of material comprising carbon dioxide is considerably lower below groundwater level. Therefore the re-entering of carbon dioxide in the environment is significantly retarded when the material is brought below groundwater level.

Preferably, the method additionally comprises, before the step of burying:
storing an indicator related to the amount of CO2 that is buried by burying said obtained material.

Commercializing the method of the invention is facilitated when the results are directly measured, meaning when keeping track of the amount of carbon dioxide that has been processed. This keeping track may be embodied by storing an indicator related to the amount of carbon dioxide in a memory. The indicator is preferably periodically stored. In a commercial setting, certificates may be linked to the indicator allowing a user to prove how much carbon dioxide has been processed in accordance with the method. Preferably, said indicator is obtained by following steps:
periodically executing a mass-spectrometry measurement on said material; and
weighing said obtained material.

The invention further relates to a device for burying a material comprising carbon dioxide, the device comprising a material receiving section for obtaining the material comprising carbon dioxide, the device further comprising a material burying section provided with a soil engaging mechanism and a material transporting system for transporting the obtained material via the soil engaging mechanism in a subsoil.

The device is used to execute the method of the invention. To this end, the device comprises a material receiving section. This material receiving section is provided to obtain the material comprising carbon dioxide that is to be buried. Furthermore, the device comprises a soil engaging mechanism as well as a material transporting system for transporting the material from the material receiving section to the soil engaging mechanism. This enables an operator of the device to provide the material comprising carbon dioxide at a material receiving section and to operate the device to bury the material into a subsoil.

Preferably, the device further comprises a coupling mechanism for operationally coupling the device with an agricultural harvester, wherein the coupling device is arranged to operationally connect the material receiving station with an output of the agricultural harvester. Material comprising carbon dioxide may be obtained by harvesting crop material. Agricultural harvesters or combines are known for enabling efficient harvesting of crop material. The type of agricultural harvester or combine may be chosen depending on the type of crop to be harvested. By operationally coupling the device of the invention with the agricultural harvester, a continuous and efficient way may be provided to harvest crop material via the harvester and to bury the obtained material via the device of the invention. In this manner, a significant amount of carbon dioxide may be withdrawn or drained from the atmosphere. In this context it is noted that the crop material uses carbon dioxide in the atmosphere to grow. By harvesting and burying this crop material, the carbon dioxide becomes captured in the subsoil, thereby preventing the carbon dioxide, used by the crop material to grow, to re-enter the atmosphere.

Preferably, the device further comprises a material compressing section adapted to compress material from the material receiving section before transporting the material in the subsoil. Further preferably, the compressing section comprises an extruder adapted to compress the material into an elongated sausage like structure to be further transported by the soil engaging mechanism in a subsoil. By compressing the crop material into an elongated sausage like structure, burying is more simple. Techniques also known in the draining technology, where a draining pipe is buried in a subsoil, may be used to bury the elongated sausage like structure into the subsoil. In this context it is noted that the elongated sausage may be segmented into separate pieces. The separate pieces are considered discrete packages of crop material whereas the elongated sausage like structure may be considered a continuous package of crop material.

Preferably, the compressing section further comprises a wrapping mechanism to wrap the elongated sausage like structure into a foil. The foil prevents oxygen from reaching the material containing carbon dioxide so that decomposing or natural decaying is prevented or at least retarded.

Preferably, the soil engaging mechanism comprises a soil-cutting knife, the soil-cutting knife being preferably mounted via an actuator to the device to conduct a back-and-fort movement in an upward and/or transverse direction. The soil-cutting knife cuts into the soil to reach the subsoil. This provides space for inserting the material comprising carbon dioxide in the subsoil. Soil-cutting technology analogue to technology used for arranging draining pipes may be used.

Alternatively, the soil engaging mechanism comprises a soil-lifting mechanism adapted to lift a predetermined area of soil and wherein the material transporting system is adapted to transport material in the space created by lifting the predetermined area of soil.

The invention will now be described in more details with respect to the drawings illustrating some preferred embodiments of the invention. In the drawings:

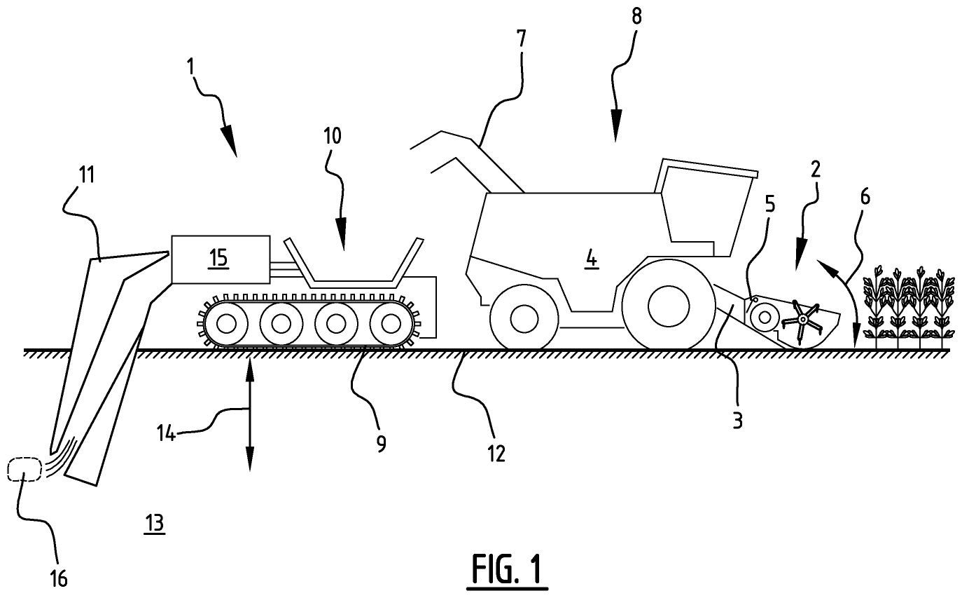

FIG. 1 illustrates a device of a first preferred embodiment of the invention; and

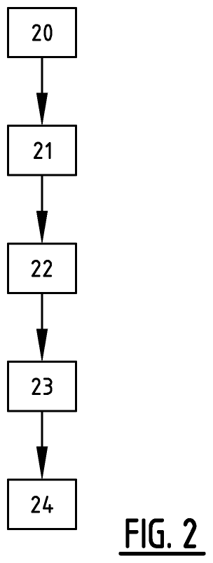

FIG. 2 illustrates the steps of a method of a preferred embodiment of the invention.

In the drawings a same reference number has been allocated to a same or analogous element.

In the context of this description, the term ‘burry’ and ‘burying’ is defined as to dig a hole in the ground, deposit an object, cover it up and leave it. This may in the context be done continuously meaning to dig a way through the ground creating a tunnel while depositing and leaving an object in the tunnel on the go.

FIG. 1 shows a side view of a device 1 of an embodiment of the invention, operationally connected to a combine 8. In operation of the combine 8, a header 2 is connected to the combine 8. The combine 8 comprises a feeder 3 which is connected to the header 2 via a header mounting frame 5 provided at the frontal end of the feeder 3, and is provided for taking in harvested crop material from the header 2 towards the body 4 of the combine 8.

The header 2 has to be at a height and has to be positioned in a fore-aft position with respect to the combine 8. Thereby the fore-aft position defines the angle between the cutting knives of the header and the ground surface. The height is determined by the angular position of the feeder 3 with respect to the combine 8. Tests have shown that an ideal fore-aft position depends on the type of crop material to be harvested. Increasing the height of the header 2 can be easily achieved by lifting the header via the feeder 3.

The change of position of the header 2 with respect to the combine 8 is illustrated in FIG. 1 with reference number 6. This position is determined by a combination of the fore-aft position and the height of the header 2. The fore-aft movement is defined as a movement of the header mounting frame 5 with respect to the feeder 3 around an axis which is substantially horizontal and transverse to the forward driving direction of the agricultural vehicle 1.

The combine 8 preferably processes, for example by chopping, the crop material in the body 4 and expels at least part of the crop material at the outlet 7. When the device for burying the material comprising carbon dioxide is operationally connected to the combine, the crop material expelled by the combine is received at the material receiving section of the device 1. In this context it is noted that the operational connection does not necessarily mean a physical connection between the combine 8 and the device 1. The operational connection may be realized by driving the device at a predetermined distance from the combine 8 via sensors and/or communication mechanisms. Alternatively, a physical connection may be made with the combine 8, for example by connecting the device as a trailer behind the combine 8. When a physical connection is made, also the outlet 7 of the combine 8 may be physically connected to the material receiving section 10, or be integrated with the receiving section 10. Further alternative, the operational elements of the device, further described hereunder, may be fully integrated into the combine body 4 so that the combine integrates the functions of the device 1.

The device 1 further comprises soil engaging mechanism 11 and a crop material transporting system adapted to transport the crop material from the material receiving section 10 to the soil engaging mechanism 11. The transporting system may transport the crop material via a crop processing system 15, if processing of the crop material is desired.

The soil engaging mechanism may be formed in multiple different ways. The function of the soil engaging mechanism is to provide a space below the ground surface, in other words in a subsoil, where the material comprising carbon dioxide may be inserted. In other words, a hole is made in the ground and an access is provided towards a lower part of the hole so that the transporting system may transport the material comprising carbon dioxide towards a bottom section of the hole, after which the soil engaging mechanism may at least partly close the hole. Such mechanism is in other technological fields used for example to bring a draining pipe at a predetermined depth in the ground. In FIG. 1, the soil is indicated with reference number 12. The subsoil 14 is defined as a predetermined distance 14 below the soil 12. The soil engaging mechanism 11 is in FIG. 1 shown as a knife-like element 11 which protrudes the soil 12 to reach the subsoil 13. The depth 14 may be regulated, for example by connecting the knife-like element 11 via an actuator to the device. The actuator may regulate the depth and/or may perform a fore-aft movement in the upward and/or in the transverse direction of the device to facilitate the burying. of the material.

The processing system 15 preferably comprises means for determining the amount of carbon dioxide. In one embodiment, these means comprise a mass-spectrometry measurement device and a mass measurement device. The combination of these measurements enables to accurately determine or calculate the amount of carbon dioxide that is contained in the material. This amount of carbon dioxide may then be stored in a memory, directly or indirectly, to keep track of the total amount of carbon dioxide that is buried by operating the device. This knowledge of the amount of carbon dioxide that is buried by operating the device may then in a further step be used to generate certificates which represent an economic value.

The processing system 15 preferably comprises means to shape or reshape the material comprising carbon dioxide into a form that is more suitable for burying. In one embodiment, the processing system 15 comprises an extruder adapted to compress the material comprising carbon dioxide into an elongate sausage-like structure. This elongate sausage-like structure can be handled after the extruder by a transporting means that is suitable for transporting flexible piping. In another embodiment, the processing system 15 comprises a chopper for chopping the material comprising carbon dioxide into parts that are small and/or light enough to be transported via a blowing system. In such embodiment, the material parts may be blown by a transporting means into the hole formed by the soil engaging mechanism 11. Other embodiments of reshaping are also possible, for example compressing the material into packages with predetermined volumes, which packages are transported to be buried.

The processing system 15 preferably comprises a wrapping mechanism for at least partially wrapping the material comprising carbon dioxide in a foil. The foil may be selected to serve a predetermined purpose. For example, when it is aimed to minimize subjection of the material to oxygen, a plastic foil or film is selected. The wrapping mechanism may also continuously wrap an elongate sausage-like structure to create a tube-like package of material comprising carbon dioxide which is surrounded by plastic foil or film. Alternative to a wrapping mechanism, a coating mechanism may be provided to coat an outside surface of the discrete or continuous package. In an analogue manner, the coating may be selected to improve or retard certain effects.

The processing system 15 preferably comprises a data logger operationally connected to a positioning system. The positioning system may be provided at the device and comprise a satellite positioning system such as a GPS system. Such data logger may store the location or locations or tracks where material comprising carbon dioxide has been buried. The data logger may also store the depth at which the material comprising carbon dioxide has been buried. In this way, managing of locations or zones or fields where material comprising carbon dioxide is buried, is facilitated. This enables to bury material in tracks that lay parallel and next to each other. This also enables to bury material in multiple layers above each other.

The device 1 shown in FIG. 1 comprises tracks 9. Tracks may be advantageous particularly when the forward movement of the device 1 is used to engage the soil. Tracks provide a large traction. Alternatively, wheels may be provided.

In an alternative embodiment, the soil engaging mechanism comprises a soil-lifting mechanism adapted to lift a predetermined area of soil. This soil-lifting mechanism may be operated when the device 1 stands still. It may be operated like a loader where, instead of a loader shovel, a plate like element is pressed into the subsoil and subsequently lifted to lift the plate like element. The lifting creates a space below the plate like element which may be filled with the material comprising carbon dioxide. To this end, the material transporting system is adapted to transport material in the space created by lifting the predetermined area of soil. In such alternative embodiment, the device 1 is not continuously operated, but is operated in a stepwise of cyclic manner wherein the device is brought to a predetermined position, the soil engaging mechanism is operated and material is transported into the subsoil. After such cycle, the device 1 is relocated and the soil engaging mechanism is again operated and material is transported into the subsoil.

In FIG. 1, the combine 8 and the device 1 are operationally connected. It is noted that it is alternatively possible to use a transporting vehicle to transport the crop material harvested by the combine and to transport it to another location where the device 1 buries the crop material into the subsoil. Such transportation may also be conducted oversees if this is desirable.

FIG. 2 shows the steps of the method of a preferred embodiment of the invention. The different steps and their alternatives are described hereunder. It is noted that at least some steps are optional and are only performed in predetermined embodiments.

Step 20 relates to obtaining the material comprising carbon dioxide. The material comprising carbon dioxide may comprise plastic material. Alternatively and preferably, the material comprising carbon dioxide is a natural product. The material comprising carbon dioxide may comprise a tree or a plant. Tests have shown that a forest yearly captures about 12 ton carbon dioxide for each hectare. A bamboo field may yearly capture about 300 ton carbon dioxide for each hectare. Many types or sorts of grasses yearly capture about 200 ton carbon dioxide for each hectare. The material comprising carbon dioxide is preferably a type or sort of grass because grass is easy to harvest and process. The material comprising carbon dioxide can be obtained directly or indirectly. As described above, the material can be obtained directly from a combine who harvests the material on the go. Alternatively, the material can be transported via transporting vehicles.

Step 21 relates to obtaining an indicator of an amount of carbon dioxide in the material. The step 21 of obtaining an indicator of the amount of carbon dioxide in the material is an optional step. This step 21 may also be performed after step 22 or after step 23, at least before step 24. Obtaining an indicator of the amount of carbon dioxide may be performed in different ways. One way of obtaining such indicator is conducting a mass-spectrometry measurement and conducting a mass measurement. Other techniques can equally be used to obtain or estimate the amount of carbon dioxide in the material that is processed.

Step 22 relates to compressing the material comprising carbon dioxide. Compressing the material is an optional step. Compressing the material may be executed using an extrusion process wherein preferably a conical extruder compresses the material into an elongated sausage-like structure. Such elongated sausage-like structure is considered a continuous package. Alternatively, the material may be compressed into discrete packages. This may also be done using an extruder wherein the output is chopped into pieces of a predetermined length. Alternatively discrete packages may be formed by squeezing the material into packages.

Step 23 relates to surrounding or covering or wrapping the material comprising carbon dioxide. This step 23 is an optional step. Particularly when the material cannot be buried below a groundwater level, it is advantageous to cover the material with a protective layer. This can be done by surrounding or covering or wrapping the material comprising the carbon dioxide. The protective layer is preferably a plastic foil or film. The protective layer retards or eliminates the composting or decaying of the material comprising carbon dioxide such as to maximally trap the carbon dioxide in the subsoil. This prevents the carbon dioxide from re-entering the atmosphere.

Step 24 relates to burying the material comprising carbon dioxide. In this context it has been observed that wooden constructions, which comprise carbon dioxide, tend to conserve the wood and no significant decaying or decomposing can be observed. Therefore it is expected that by burying the material comprising carbon dioxide below groundwater level, a similar effect will manifest. It is therefore preferred to bury the carbon dioxide below groundwater level. In this context it is noted that in many areas, the groundwater level is as high as one meter below the soil so that it is not complex nor expensive to bury the material comprising carbon dioxide below groundwater level. In other areas, it is not possible, and the material comprising carbon dioxide may be buried above groundwater level in the subsoil. The mechanisms to bury the material comprising carbon dioxide in the subsoil are described above and not repeated for conciseness.

Although the figures show the material receiving section and other sections in the device in relation to crop material, it will be clear that other types of materials comprising carbon dioxide may also be buried with the device of the invention. An example is plastic.

The skilled person will appreciate on the basis of the above description that the invention can be embodied in different ways and on the basis of different principles. The invention is not limited to the above described embodiments. The above described embodiments and the figures are purely illustrative and serve only to increase understanding of the invention. The invention will not therefore be limited to the embodiments described herein, but is defined in the claims.

1-14. (canceled)

15. A method for capturing and storing CO2, the method comprising:
obtaining a material comprising carbon dioxide; and
burying said obtained material in a subsoil.

16. The method according to claim 15, wherein the step of obtaining the material comprises harvesting a crop material.

17. The method according to claim 16, wherein the method further comprises, before the step of burying:
compressing the obtained material into discrete or continuous packages.

18. The method according to claim 17, wherein the step of compressing additionally comprises surrounding the discrete or continuous packages into a plastic covering.

19. The method according to claim 15, wherein the step of burying comprises bringing the material to a depth below groundwater level.

20. The method according to claim 15, wherein the method additionally comprises, before the step of burying:
storing an indicator related to the amount of CO2 that is buried by burying said obtained material.

21. The method according to claim 20, wherein said indicator is obtained by following steps:
periodically executing a mass-spectrometry measurement on said material; and
weighing said obtained material.

22. A device for burying a material comprising carbon dioxide, the device comprising:
a material receiving section for obtaining the material comprising carbon dioxide,
a material burying section provided with a soil engaging mechanism, and
a material transporting system for transporting the obtained material via the soil engaging mechanism in a subsoil.

23. The device according to claim 22, comprising a coupling mechanism for operationally coupling the device with an agricultural harvester, wherein the coupling device is arranged to operationally connect the material receiving station with an output of the agricultural harvester.

24. The device according to claim 22, further comprising a material compressing section adapted to compress material from the material receiving section before transporting the material in the subsoil.

25. The device according to claim 24, wherein the compressing section comprises an extruder adapted to compress the material into an elongated sausage like structure to be further transported by the soil engaging mechanism in a subsoil.

26. The device according to claim 25, wherein the compressing section further comprises a wrapping mechanism to wrap the elongated sausage like structure into a wrapping material.

27. The device according to claim 22, wherein the soil engaging mechanism comprises a soil-cutting knife.

28. The device according to claim 27, wherein the soil-cutting knife is mounted via an actuator to the device to conduct a back-and-fort movement in an upward and/or transverse direction.

29. The device according to claim 22, wherein the soil engaging mechanism comprises a soil-lifting mechanism adapted to lift a predetermined area of soil and wherein the material transporting system is adapted to transport material in the space created by lifting the predetermined area of soil.
